(19) United States
(12) Patent Application Publication
(10) Pub. No.: US 2013/0306754 A1
(43) Pub. Date: Nov. 21, 2013

(54) SPRAYING APPARATUS AND SPRAY MIXING APPARATUS

(71) Applicants: Campbell Bryce Easton, Dannevirke (NZ); Geoffrey James Easton, Dannevirke (NZ)

(72) Inventors: Campbell Bryce Easton, Dannevirke (NZ); Geoffrey James Easton, Dannevirke (NZ)

(73) Assignee: Metalform (Dannevirke) Limited, Dannevirke (NZ)

(21) Appl. No.: 13/895,113

(22) Filed: May 15, 2013

(30) Foreign Application Priority Data
May 17, 2012 (NZ) 600050

(51) Int. Cl. A01C 15/00; A01M 11/00

(52) U.S. Cl. CPC A01C 15/005; A01M 11/00
USPC 239/142

(57) ABSTRACT

A spraying apparatus that is particularly suited to spraying of suspensions, for example liquid suspended fertilizers. The apparatus includes a tank with an arrangement configured to create fluid circulation within the tank, thereby reducing settling of solids out of suspension. The apparatus also creates a mixing flow in a region below an opening, such that particulates can be introduced through the opening into the mixing flow.

### FIELD OF THE INVENTION

The invention relates to a spraying apparatus, particularly but not exclusively to an apparatus for spraying suspended particulate and/or biologically active material in agricultural or horticultural settings. The invention also relates to a spray mixing apparatus, particularly but not exclusively to an apparatus for mixing particulate spray materials into suspension.

### BACKGROUND TO THE INVENTION

Sprays are widely used in various applications, including horticultural and agricultural applications. Sprays include fertilizers and chemicals for pest or disease control. Liquid sprays may be sprayed directly or diluted with water. Particulate sprays may be dissolved in water or, for insoluble or partially soluble materials, suspended in water for spraying. Recently various biologically active sprays have been proposed and these are applied in a similar manner.

Sprays are typically applied by a trailer or vehicle-mounted sprayer.

Application of fine powders in suspension is desirable because it provides faster chemical uptake and reduces undesirable runoff into waterways. However, fine powders are difficult to apply. Prior sprayers suffer from poor formation or maintenance of the suspension (i.e. the powder does not mix adequately with water or settles out after mixing but before spraying). If powder settles from the suspension it can solidify into an extremely hard substance which is difficult to clean. The settled powder is also wasted. These difficulties also lead to undesirable variation in application rates and increased costs.

The Applicant devised certain apparatus and methods as disclosed in its patent application no. PCT/NZ2011/000086 published as WO2011/149365, the contents of which are hereby incorporated by reference herein. In some embodiments that apparatus uses a single pump to cause mixing of particulates into fluid and spraying of the suspended particulates. The Applicant has found that there is room for further improvement, particularly but not exclusively in higher volume spraying machines.

It is an object of the invention to provide an improved spraying system and/or spray mixing apparatus or at least to provide the public with a useful choice.

### SUMMARY OF THE INVENTION

In a first aspect the invention provides a spraying apparatus including:

a tank configured to receive a volume of fluid;

an opening at an upper part of the tank for introduction of particulates into the volume of fluid;

a spray arrangement including one or more spray outlets;

a fluid outlet in the tank, through which fluid may flow to the spray arrangement; and

an impeller mounted in a housing within the tank so as to cause fluid flow through the housing, thereby creating fluid flow within the tank.

Preferably, in use, the fluid flow within the tank prevents particulate from settling out of suspension.

Preferably the fluid flow within the tank provides a mixing flow for mixing of particulates into the fluid.

Preferably the impeller and the opening are arranged such that the fluid flow created by the impeller forms a mixing flow in a region below the opening.

Preferably the mixing flow is a flow downwards and across the opening.

Preferably the mixing flow meets a main fluid body in a region of high turbulence.

Preferably the impeller is positioned near the bottom of the tank.

Preferably the impeller, a first wall of the tank and the opening are arranged such that the impeller causes fluid flow across a lower region of the tank towards the first wall of the tank, upwards near the first wall of the tank and away from the first wall of the tank beneath the opening.

Preferably the first wall of the tank is a curved wall configured to encourage redirection of the fluid flow.

Preferably, in a plane perpendicular to a rotational axis of the impeller, the tank widens from a narrow region in a lower part of the tank in which the propeller is positioned to a wider region above the lower part.

Preferably the impeller is arranged to receive power from a power take-off drive.

Preferably the housing is an elongate housing.

Preferably the housing forms an elongate tunnel within which the impeller is positioned.

Preferably the impeller is positioned at a point along the length of the housing.

Preferably the spraying apparatus further includes a pump arranged to supply fluid from the tank to the spray arrangement.

Preferably the spray arrangement is a recirculating spray arrangement

Preferably the spray arrangement includes a flow loop leading from the tank and returning to the tank and one or more spray outlets positioned in the flow loop; the pump being arranged to cause flow of fluid from the tank through the flow loop, and the apparatus being configured such that, during spraying, only a portion of fluid passing through the flow loop exits through the spray outlets, with the remainder of the fluid returning to the tank for recirculation.

Preferably the flow loop includes one or more spray booms, one or more of the spray outlets being positioned in each spray boom.

Preferably the spraying apparatus includes a spray valve positioned downstream of the spray outlets, the spray valve having an open position and at least one restricted flow position, wherein the pressure at the spray outlets is higher when the spray valve is in the restricted flow position than when it is in the open position.

Preferably the spraying apparatus is configured to spray less than 20% of fluid passing through the flow loop. Preferably the spraying apparatus is configured to spray around 3 to 10% of fluid passing through the flow loop.

Preferably the spraying apparatus is configured to supply fluid to the spray arrangement at a rate in the range 500 to 800 litres per minute.

Preferably the spraying apparatus is configured as a trailer for towing behind a vehicle or configured to be mounted on a vehicle.

Preferably the spraying apparatus is configured to operate at a pressure less than 35 pounds per square inch. Preferably the spraying apparatus is configured to operate at a pressure less than 30 pounds per square inch. Preferably the spraying apparatus is configured to operate at a pressure less than 25 pounds per square inch.

Preferably the spraying apparatus is configured to maintain a particulate in suspension in the tank for spraying.

Preferably the material to be sprayed is or includes a particulate material and is sprayed in suspension.

Preferably the particulate has an average particle size less than 100 microns. Preferably the particulate has an average particle size less than 50 microns. Preferably the particulate has an average particle around 5 microns.

Preferably the material to be sprayed is or includes a component that is biologically active.

Preferably the spraying apparatus is an agricultural or horticultural spraying apparatus.

In a second aspect the invention provides a spray mixing apparatus including:

a tank configured to receive a volume of fluid;

an opening at an upper part of the tank for introduction of particulate spray material into the volume of fluid; and

an impeller mounted in a housing within the tank so as to cause fluid flow from the tank through the housing, thereby creating fluid flow within the tank.

Preferably the apparatus further includes a fluid outlet in the tank, through which fluid may be pumped.

Preferably the fluid flow within the tank provides a mixing flow for mixing of particulates into the fluid.

Preferably the impeller and the opening are arranged such that the fluid flow created by the impeller forms a mixing flow in a region below the opening.

Preferably the mixing flow s a flow downwards and across the opening.

Preferably the mixing flow meets a main fluid body in a region of high turbulence.

Preferably the impeller is positioned near the bottom of the tank.

Preferably the impeller, a first wall of the tank and the opening are arranged such that the impeller causes fluid flow across a lower region of the tank towards the first wall of the tank, upwards near the first wall of the tank and away from the first wall of the tank beneath the opening.

Preferably the first wall of the tank is a curved wall configured to encourage redirection of the fluid flow.

Preferably, in a plane perpendicular to a rotational axis of the impeller, the tank widens from a narrow region in a lower part of the tank in which the propeller is positioned to a wider region above the lower part.

Preferably the impeller is arranged to receive power from a power take-off drive.

Preferably the housing is an elongate housing.

Preferably the housing forms an elongate tunnel within which the impeller is positioned.

Preferably the impeller is positioned at a point along the length of the housing.

Preferably the apparatus further includes a pump arranged to pump mixed spray material from the tank.

Preferably the apparatus is configured to maintain a particulate in suspension in the tank.

Preferably the particulate spray material has an average particle size less than 100 microns. Preferably the particulate spray material has an average particle size less than 50 microns. Preferably the particulate spray material has an average particle around 5 microns.

The word “fluid” is used in this specification to mean liquids and solutions but also suspensions of particulates in fluids.

### BRIEF DESCRIPTION OF THE DRAWINGS

The invention will now be described by way of example only, with reference to the accompanying drawings, in which:

FIG. 1 is a top perspective view of an apparatus according to one embodiment;

FIG. 1A is a bottom perspective view of the apparatus of FIG. 1;

FIG. 2 is a front view of the apparatus of FIG. 1;

FIG. 3 is a simplified cross-section along the line 3-3 in FIG. 2;

FIG. 4 shows a propeller in a housing, as used in the apparatus of FIG. 1;

FIG. 5 is a schematic diagram showing flow paths in an apparatus according to a further embodiment;

FIG. 6 is a schematic diagram showing flow paths in the apparatus of FIG. 1; and

FIG. 7 further illustrates flow paths in the apparatus of FIG. 1.

### DETAILED DESCRIPTION

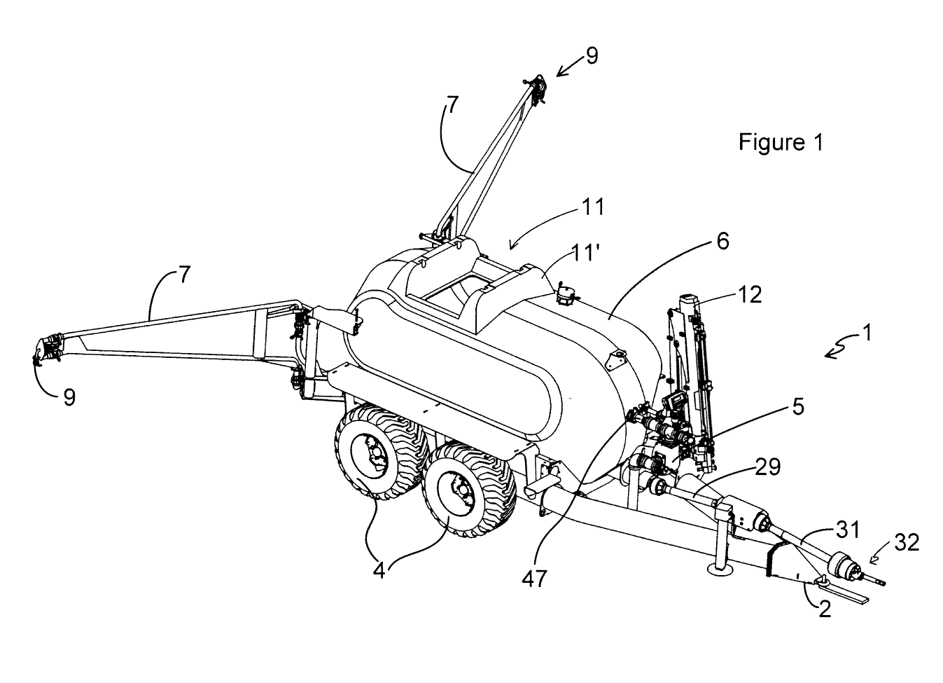

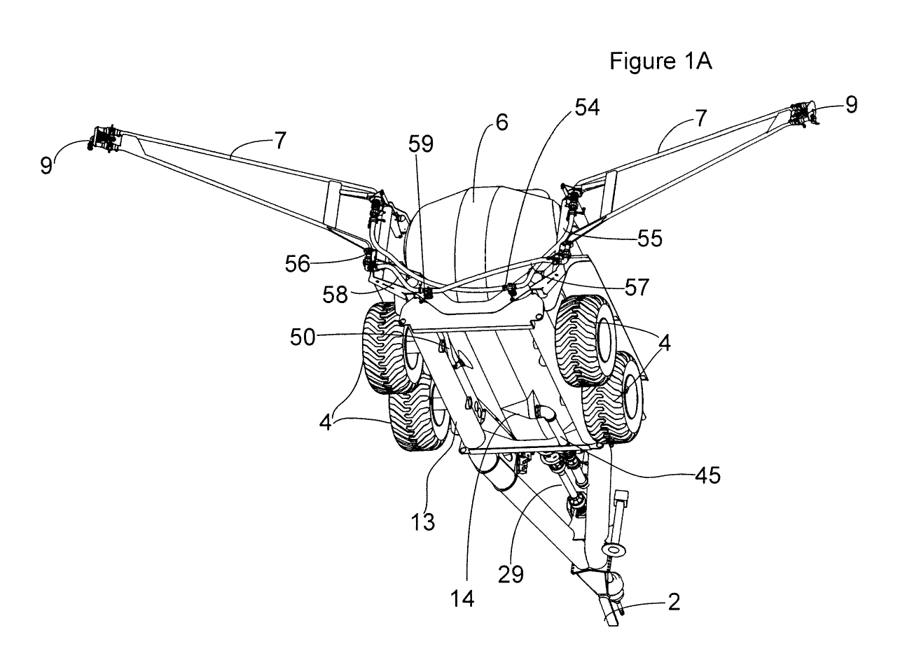

FIG. 1 shows a spraying apparatus 1 configured as a trailer unit for towing behind a vehicle. The apparatus 1 includes a towbar 2 for connection to the towing vehicle. The apparatus is supported on a number of wheels 4.

The apparatus 1 includes a pump 5, tank 6 and one or more spray booms 7. The pump operates to supply spray fluid from the tank 6 through the spray booms 7 to spray outlets 9.

The pump 5 may be any suitable pump for maintaining the required pressures and flow rates. In one embodiment the pump 5 may be a hydraulic pump and may be connected to a tractor or truck hydraulic supply. However, other suitable pumps may be used, including petrol-powered pumps, for example.

The tank 6 may be formed of any suitable material, preferably of moulded plastic. The tank 6 has an opening 11 which allows fluids (e.g. water) and spray materials to be added to the tank, and also allows user access to the tank interior. Alternatively, further openings, for example a hose connector, may be provided for addition of water or other fluids to the tank 6. The opening 11 may be provided with a raised rim 11′.

In a preferred embodiment the spray booms 7 form part of a closed flow loop as discussed in the Applicant's WO2011/149365, the contents of which are hereby incorporated by reference herein. That is, fluid to be sprayed flows from the tank to the spray booms and then back to the tank. Only a part of the fluid circulating in this way is sprayed from the outlets 9 with any one circulation.

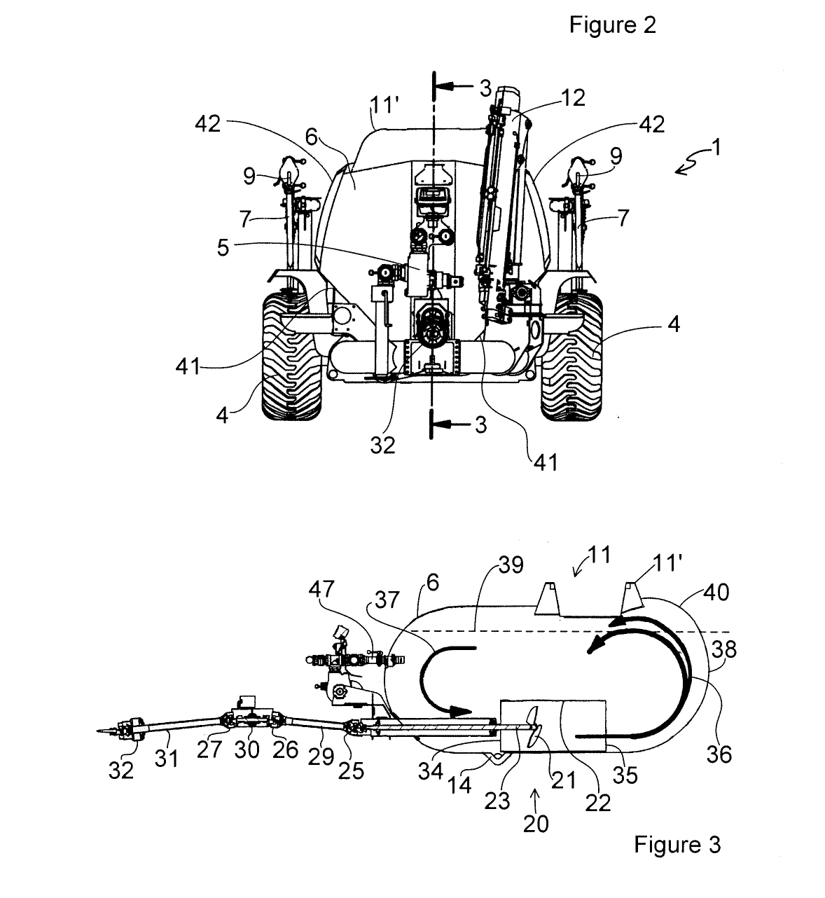

In the embodiment shown the spray booms 7 are mounted to fold back along the sides of the tank 6 for ease of transport, as shown in the front view of FIG. 2, and to fold out to the operating position of FIG. 1. However, in other embodiments the spray boom may be fixed or indeed no spray boom need be provided. For example, a flow path could lead to single spray outlet positioned underneath or at the rear of the tank 6.

In the embodiment shown a crane 12 is mounted near the front of the tank 6. This allows very large bags of particulate to be lifted for introduction into the tank opening 11. While particulates can be stored in small sacks up to around 50 kg, they may also be provided in much larger bulk sacks or bags of around 0.5-1 tonne in weight. Clearly such large sacks or bags cannot be manually lifted, and must he lifted either by a crane 12, or if the apparatus 1 does not include a crane 12, by a separate machine such as a front-end loader, forklift or the like.

In one embodiment the tank may have a capacity of approximately 2 to 20 cubic metres, preferably 2 to 10 cubic metres, ideally 2 to 5 cubic metres.

FIG. 1A is a bottom perspective view of the apparatus of FIG. 1. This shows the chassis 13 of the apparatus 1 and the underside of the tank 6. An outlet 14 at a low point of the tank 6 is provided for pumping of spray material from the tank 6 via conduit 45, as will be discussed further below.

FIG. 2 is a front view of the spraying apparatus 1. FIG. 3 is a section along the line 3-3 shown in FIG. 2. FIG. 3 is provided to show the tank shape, impeller and housing as described below, and for clarity many other features are omitted from FIG. 3.

An impeller 21 is mounted in the tank 6, preferably near the bottom of tank 6. The impeller 21 may be based on any suitable rotor or propeller. The impeller 21 is mounted in a housing 22. The housing may form an elongate tunnel within which the impeller is positioned.

The impeller 21 is mounted on a shaft 23. The shaft 23 is connected via couplings 25, 26, 27 and further shafts 29, 30, 31 to a power take-off (“PTO”) coupling 32 that is configured for connection to the PTO of a farm tractor or other suitable drive system. In one embodiment this arrangement therefore provides a rotor driven by the PTO system of a towing vehicle. In other embodiments the tank may be mounted directly on a truck chassis or truck bed and the impeller may be powered by the truck's PTO system.

The shaft 31, with couplers 27, 32 may be a removable, extendible shaft that can be attached once the apparatus is hitched to a towing vehicle by the tow-bar 2.

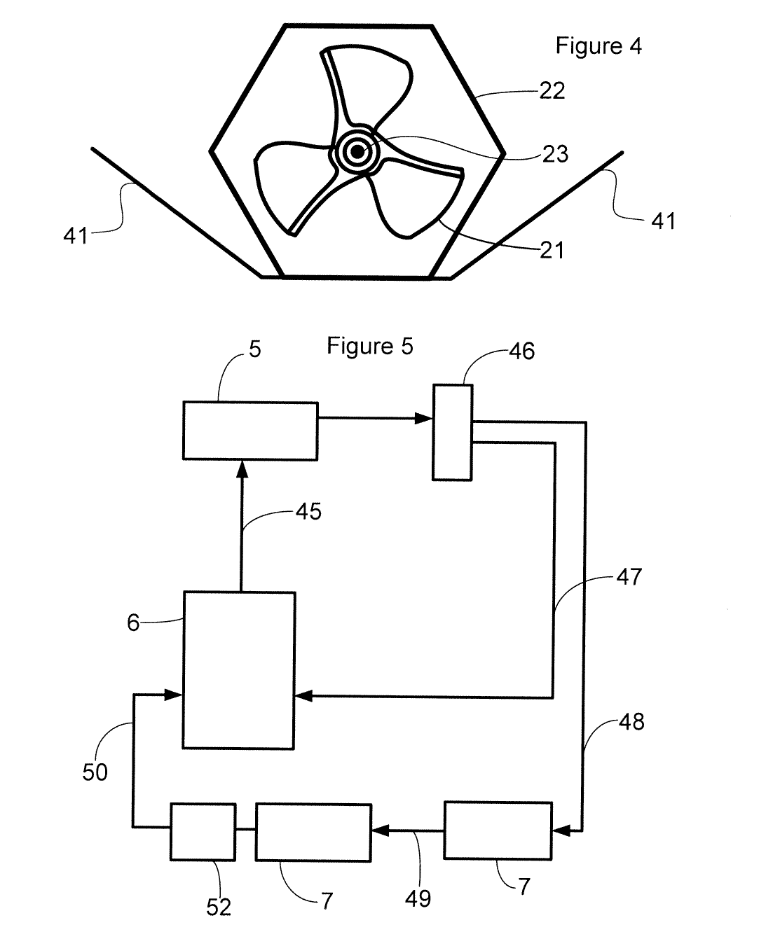

FIG. 4 is an end view of the housing 22, rotor 21 and shaft 23. The cross-sectional shape of the housing may vary, and may be circular, elliptical or polygonal. In the embodiment shown the housing is hexagonal.

Rotation of the impeller 21 causes fluid to flow in a first end 34 of the housing 22 and out a second end 35 of the housing 22. This highly directional flow causes circulation of fluid within the tank, as indicated by the arrows 36, 37. Flow towards the back of the tank 6 is forced upwards as it meets the back wall 38. At sufficient impeller power, the fluid will flow upwards in this region beyond the level 39 at which the fluid surface would lie in the absence of any flow. The level 39 is marked by a dashed line 39 in FIG. 3. However note that this level 39 will vary, and in particular will fall as material is sprayed from the spraying apparatus 1. Fluid then flows forwards past the opening 11. As the power provided by the impeller 21 increases, the flow 36 also becomes increasingly powerful. At sufficient impeller power, the forward flow past the opening 11 forms a descending mixing or curtain flow, with fluid passing from the back of the tank forwards and downwards past the opening 11 before meeting the body of fluid in a highly turbulent manner. This creates a very efficient mixing zone immediately under the opening 11 for the introduction of particulates into the fluid. Particulate introduced into the opening 11 is captured by the curtain flow and forced downwards into a region of high turbulence. Fluid then flows forwards in the tank and re-enters the housing 22, as indicated by the arrow 37.

In some embodiments the creation of the curtain flow past the opening 11 may be enhanced by suitable shaping of the tank walls. As shown in FIG. 3, the rear wall 38 of the tank may be curved to encourage flow as marked by arrow 36. Further, the upper part 40 of the rear wall may be shaped to encourage flow forwards and downwards past the opening 11. As shown, the upper part 40 of the rear wall 38 is higher than the opening 11 and slopes downwards towards the opening 11.

The formation of the curtain flow may also be assisted by the shape of the tank in a plane perpendicular to the plane shown in FIG. 3. As shown in FIG. 4 (and see also FIG. 2) the propeller is mounted in a lower part of the tank, with side walls 41 extending outwards in a substantially V-shaped configuration. At the top of the V-shaped portion, upper side walls 42 may extend upwards, or may even be angled slightly inwards as shown in FIG. 2. The narrow lower part of the tank helps to create a strong linear flow in the lower part of the tank. As the flow moves upwards and then forwards (as indicated by arrows 36 in FIG. 3) the tank widens and the fluid flow therefore also widens, and this helps to form a wide curtain flow moving forwards past the opening 11.

This mixing mechanism is highly effective. The curtain flow and turbulent mixing region captures the particulate and mixes it effectively. In preferred embodiments there is no need for a gradual introduction of particulate. Particulate can be introduced in bulk and extremely quickly to the fluid volume.

The Applicant has found that in a tank of approximately 4 cubic metres, a one tonne bag of particulate fertilizer can be added to the fluid volume simply by lifting the bag over the opening 11 and rapidly emptying the bag into the opening over a period of around 20 to 40 seconds. There is no or only minor splashing or loss of particulate. Furthermore, the particulate is very effectively mixed—particulate does not stay unmixed on the fluid surface to any significant extent.

The dimensions of the tank, impeller and housing, as well as the required impeller power, will depend on the application and the material being sprayed, as well as on each other. For example, a larger tank may require a larger propeller power. A thicker spray material suspension will require a greater propeller power.

In one embodiment the tank may have a volume of around 4 cubic metres. The propeller may have a diameter around 400 mm, with the housing extending around 800 mm downstream of the propeller. The housing may be sized to provide a clearance of around 5-50 mm around the propeller. The Applicant has found that such a spraying apparatus is capable of quickly and efficiently mixing around 3 tonnes of lime into around one tonne of water, creating a paste that is too thick to be sprayed through conventional spray nozzles. The apparatus is therefore not limited by the mixing capability.

The length of the housing is preferably sufficient to create directional flow from the end 35 of the housing. Preferably the downstream end 35 of the housing 22 is positioned sufficiently near to the back wall 38 of the tank 6 to cause the desired flow patterns beneath the opening 11 as discussed above.

Thus mixing of particulate into the fluid volume and constant circulation of the fluid within the tank 6 is provided by the single housed rotor 21. In some embodiments the rotor may be used at a higher power for addition and mixing of particulates, and at a relatively lower power once the mixing process is complete. The lower power may be sufficient to cause circulation of fluid within the tank, thereby preventing settling of particulates out of suspension.

Although the preferred embodiment shown has flow through the housing towards the back wall 38 of the tank 6, in other embodiments the flow may be forwards or sideways, with the opening appropriately positioned such that the curtain flow is beneath the opening.

FIG. 5 is a schematic diagram showing the flow paths provided in one embodiment.

The pump 5, via flow conduit 45, takes fluid or suspension from the tank 6 and pumps that fluid into a manifold 46. The manifold has two outlets. In some embodiments the manifold may be replaced by a T-junction. Adjustable valves may be associated with one or more of the outlets in some embodiments.

A first outlet leads back to the tank 6 via flow conduit 47. This flow path caters for excess fluid that is moved by the pump 5 but cannot pass through the spray arrangement. The pump may therefore be a simple fixed rate pump. This flow path also maintains a circulation of fluid through the pump, flow conduit 45 and manifold 46 even when the spray arrangement and its associated flow lines are empty, such as may be the case, for example, when the apparatus is first filled. However, in some embodiments this flow path 47 (and the manifold 46) may be dispensed with.

A second outlet leads to the spray arrangement, through flow conduits 48, 49, 50 and spray booms 7, and returns to the tank 6.

A back pressure valve, or spray control valve, 52 may be provided to control the spray pressure. The function of this valve is described in the Applicant's WO2011/149365. This valve 52 has a first, open position in which fluid or suspension can flow freely through the flow paths 48, 49, 50 and booms 7. In this position pressure does not build up significantly in the booms 7 and this pressure is not sufficient to actuate the spray mechanism shown in FIGS. 13 and 14 of WO2011/149365. Therefore, when the spray control valve is open fluid or suspension is not sprayed.

The spray control valve 52 also has a second, restricted flow position. In this position flow through the valve is restricted, and this creates a higher pressure in the flow conduits 48, 49, 50 and booms 7. This higher pressure is sufficient to actuate the spray mechanism, so when the spray control valve is in this restricted flow position, fluid or suspension is sprayed.

The spray control valve may be controlled remotely from the vehicle towing the spraying apparatus, using any suitable mechanical, wired or wireless control system.

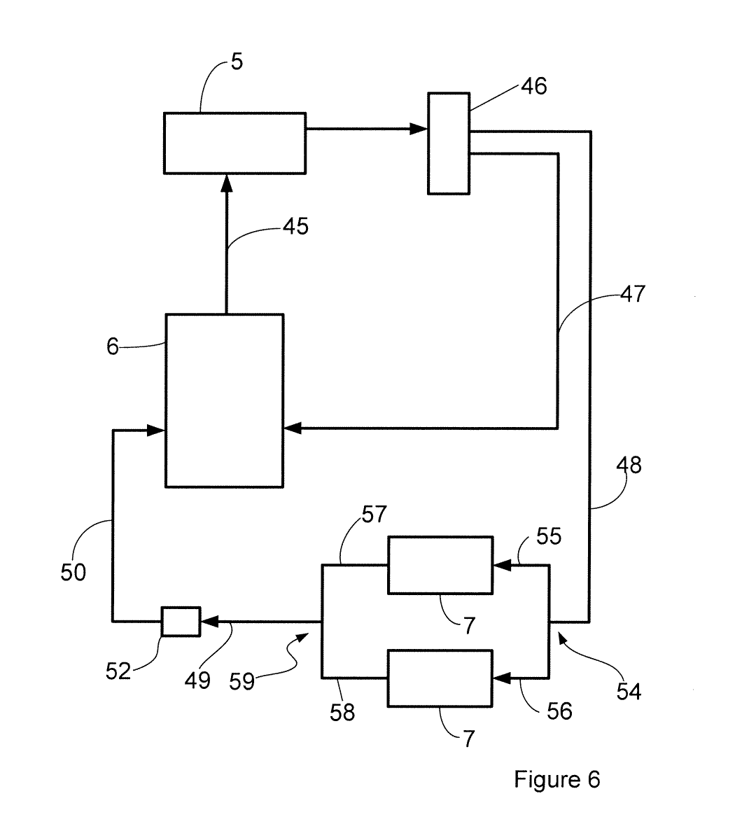

FIG. 6 is a schematic diagram showing the flow paths provided in a further embodiment. This embodiment is substantially similar to that of FIG. 5, except that two spray booms 7 are connected in parallel rather than in series, and this is the arrangement used in the apparatus of FIGS. 1 to 4. Many of the flow conduits shown in FIG. 6 can be seen in FIGS. 1 and 1A. The flow conduit 48 leads to a junction 54, which connects to two flow lines 55, 56 each leading to a spray boom 7. The spray booms are connected to further flow lines 57, 58 and thence to a further junction 59. Flow conduit 49 leads from the further junction 59 to a spray control valve 52. A further flow conduit 50 leads from the spray control valve back to the tank 6.

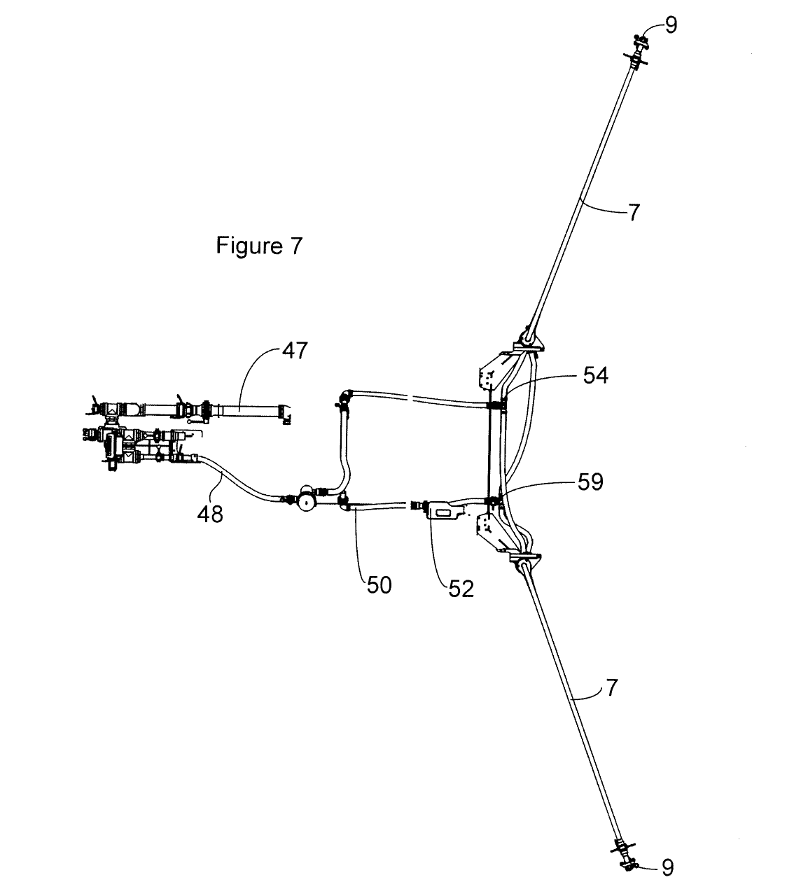

FIG. 7 shows the flow paths employed in the apparatus of FIG. 1. For clarity the tank and other components of the apparatus have been removed.

The spraying arrangement, i.e. the spray booms, nozzles and pressure actuated mechanism may be as described in WO2011/149365. In preferred embodiments a recirculating spray arrangement is used, in which spray fluid is pumped through the spray loop with only a portion of that fluid exiting through the spray outlets. That portion may be less than 2%, but is preferably less than 20%, ideally around 3 to 10% by volume. The Applicant's recirculating flow path provides excellent performance with liquid suspended fertilizers and prevents clogging in the spray loop.

The invention may be applied to various spraying systems, including systems configured as trailers for towing behind vehicles and vehicle mounted spraying systems.

The system preferably operates to supply fluid to the spray loop at around 500 to 800 litres per minute. Fluid is preferably supplied at a pressure less than 35 pounds per square inch, more preferably less than 25 pounds per square inch. This low pressure helps to prevent damage to biologically active components of the spray material or fluid. Where particulates are to be sprayed, these will preferably have an average particle size less than 100 microns, preferably less than 50 microns, more preferably around 5 microns.

The Applicant's system provides for improved initial mixing of powders into a fluid using the housed impeller and curtain flow below the opening, as described above. This means that insoluble powders move effectively and quickly into suspension and are less likely to float on the fluid surface.

Once a suspension has been formed, the housed rotor or propeller maintains the particulates in suspension by maintaining flow within the tank, preferably including flow across the bottom of the tank.

The housed impeller may be driven by a PTO mechanism. Tractors and other vehicles with PTO drives are capable or providing more than enough power to drive the impeller to perform mixing and agitation.

The recirculating spray loop is arranged to apply only a portion of spray from the spray outlets with each circulation. This also helps to keep the fluid moving, maintaining the suspension and preventing clogging around the spray outlets.

The Applicant's apparatus is therefore extremely effective for application of all sprays and in particular for application of liquid suspended sprays. The features discussed above allow very thick suspensions to be formed, maintained and sprayed. In fact the housed rotor or propeller mechanism discussed above is capable of mixing particulate into an extremely thick suspension or paste. This means that the thickness of the suspension is limited by the capacity of the spray nozzles etc to handle such thick materials, not by the ability to mix particulate into the suspension. This in turn means that a sprayer of a given size can apply spray to a larger area before refilling.

Any suitable spray materials may be used, including lime, magnesium sulphate, seaweed and other fertilizers, including urea, diammonium phosphate (DAP) fertilizers, bio-fertilizers (which may include nutrients and/or living bacteria or other organisms). All manner of fine ground insoluble or soluble fertilizers may be used. Liquid, soluble solid and insoluble powders can all be sprayed. Further, the apparatus may be suitable for hydroseeding applications (i.e. the spraying of suspended seed).

The apparatus is suited to spraying in agricultural and horticultural applications, but may also find application in other areas.

Furthermore, the Applicant's apparatus may also be used to mix sprays before moving the spray material into a separate spraying apparatus. In this embodiment the spray mixing apparatus is a standalone unit without a spraying arrangement.

The tank, housed impeller and mixing flow may be as described above. However, the pump may be arranged to pump the mixed spray material to a tank in a separate spraying apparatus (such as a truck or aircraft-mounted spraying apparatus).

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. A spraying apparatus including:
i) a tank configured to receive a volume of fluid;
ii) an opening at an upper part of the tank for introduction of particulates into the volume of fluid;
iii) a spray arrangement including one or more spray outlets;
iv) a fluid outlet in the tank, through which fluid may flow to the spray arrangement; and
v) an impeller mounted in a housing within the tank so as to cause fluid flow through the housing, thereby creating fluid flow within the tank.

2. A spraying apparatus as claimed in claim 1 wherein, in use, the fluid flow within the tank prevents particulate from settling out of suspension.

3. A spraying apparatus as claimed in claim 1 wherein the fluid flow within the tank provides a mixing flow for mixing of particulates into the fluid.

4. A spraying apparatus as claimed in claim 1 wherein the impeller and the opening are arranged such that the fluid flow created by the impeller forms a mixing flow in a region below the opening.

5. A spraying apparatus as claimed in claim 4 wherein the mixing flow is a flow downwards and across the opening.

6. A spraying apparatus as claimed in claim 4 wherein the mixing flow meets a main fluid body in a region of high turbulence.

7. A spraying apparatus as claimed in claim 1 wherein the impeller is positioned near the bottom of the tank.

8. A spraying apparatus as claimed in claim 1 wherein the impeller, a first wall of the tank and the opening are arranged such that the impeller causes fluid flow across a lower region of the tank towards the first wall of the tank, upwards near the first wall of the tank and away from the first wall of the tank beneath the opening.

9. A spraying apparatus as claimed in claim 8 wherein the first wall of the tank is a curved wall configured to encourage redirection of the fluid flow.

10. A spraying apparatus as claimed in claim 1 wherein, in a plane perpendicular to a rotational axis of the impeller, the tank widens from a narrow region in a lower part of the tank in which the propeller is positioned to a wider region above the lower part.

11. (canceled)

12. (canceled)

13. A spraying apparatus as claimed in claim 1 wherein the housing forms an elongate tunnel within which the impeller is positioned.

14. (canceled)

15. A spraying apparatus as claimed in claim 1 further including a pump arranged to supply fluid from the tank to the spray arrangement.

16. (canceled)

17. A spraying apparatus as claimed in claim 15, wherein the spray arrangement includes a flow loop leading from the tank and returning to the tank and one or more spray outlets positioned in the flow loop; the pump being arranged to cause flow of fluid from the tank through the flow loop, and the apparatus being configured such that, during spraying, only a portion of fluid passing through the flow loop exits through the spray outlets, with the remainder of the fluid returning to the tank for recirculation.

18. (canceled)

19. A spraying apparatus as claimed in claim 17, including a spray valve positioned downstream of the spray outlets, the spray valve having an open position and at least one restricted flow position, wherein the pressure at the spray outlets is higher when the spray valve is in the restricted flow position than when it is in the open position.

20. A spraying apparatus as claimed in claim 17 configured to spray less than 20% of fluid passing through the flow loop.

21. (canceled)

22. A spraying apparatus as claimed in claim 17 configured to supply fluid to the spray arrangement at a rate in the range 500 to 800 litres per minute.

23. (canceled)

24. A spraying apparatus as claimed in claim 1 configured to operate at a pressure less than 35 pounds per square inch.

25. (canceled)

26. (canceled)

27. A spraying apparatus as claimed in claim 1 configured to maintain a particulate in suspension in the tank for spraying.

28. (canceled)

29. (canceled)

30. (canceled)

31. (canceled)

32. (canceled)

33. A spraying apparatus as claimed in claim 1, being an agricultural or horticultural spraying apparatus.

34. A spray mixing apparatus including:
i) a tank configured to receive a volume of fluid;
ii) an opening at an upper part of the tank for introduction of particulate spray material into the volume of fluid; and
iii) an impeller mounted in a housing within the tank so as to cause fluid flow from the tank through the housing, thereby creating fluid flow within the tank.

35.-52. (canceled)
